(19) United States
(12) Patent Application Publication
(10) Pub. No.: US 2010/0143690 A1
(43) Pub. Date: Jun. 10, 2010

(54) PRODUCTION OF COMPOSITE MATERIALS WITH HIGH THERMAL CONDUCTIVITY

(75) Inventors: Francisco Javier Narciso Romero, Alicante (ES); Richard Prieto Alfonzo, Alicante (ES); Enrique Louis Cereceda, Alicante (ES); Jose Miguel Molina Jorda, Alicante (ES)

Correspondence Address: CANTOR COLBURN, LLP, 20 Church Street, 22nd Floor, Hartford, CT, 06103, US

(73) Assignee: UNIVERSIDAD DE ALICANTE, San Vicente del Raspeig, Alicante (ES)

(21) Appl. No.: 12/514,002

(22) PCT Filed: Mar. 14, 2008
(86) PCT No.: PCT/ES2008/000146

§ 371 Date: Feb. 8, 2010

(30) Foreign Application Priority Data
Mar. 27, 2007 (ES) P200700804

(51) Int. Cl. B32B 5/16; B22D 19/14; B32B 15/04

(52) U.S. Cl. 428/293.1; 164/91; 428/323

(57) ABSTRACT

“Disclosed is high thermal conductivity materials used as heat dissipaters in microelectronic and optoelectronic devices and power generators. Also disclosed is development of composite materials with high thermal performance and low production costs for use in semiconductor devices as heat dissipaters and a process for producing this material. The materials have a thermal conductivity above 200 Wm⁻¹K⁻¹ and a coefficient of thermal expansion in the range of 2 to 10×10⁻⁶K⁻¹ (measured in the temperature range of 20 to 300° C. in at least two directions). The composite material is constituted in three phases: a phase consisting mainly of graphite flakes; a phase comprising particles or fibers of a flake separating material, selected from a ceramic material (such as SiC, BN, AlN, TiB₂ and diamond) and carbon fibers, of high thermal performance in at least one direction; and a phase consisting of a metal alloy.”

The present invention is related to materials with high thermal conductivity for use as heat dissipaters in microelectronic and optoelectronic equipment and power generators.

### STATE OF THE ART

As dissipation of heat in the new generation of microelectronic and optoelectronic devices and in power electronics is a very important problem to be resolved by the electronics industries, great efforts are being made to develop new materials with high thermal performance that might offer solutions to this problem. The different thermal transport mechanisms acting in microelectronic and optoelectronic devices and systems and in power generators increase the complexity of the problem still further. There have been many solutions adopted to reduce excessive heat in these devices, some of which are described below.

One of the questions that is currently receiving special attention is the optimisation of the materials used in packaging systems in microelectronic and optoelectronic devices and power generators as it is necessary to eliminate heat in the various components of their structure: semiconductor, ceramic substrates, metal connections, polymers and materials used in soldered connections. One of the techniques used to maintain the temperature of devices within acceptable limits is the use of heat dissipaters.

In general, a heat dissipater is a device, manufactured with materials of high thermal conductivity, that is able to extract the heat generated by another object with which it is in thermal contact (or direct contact). Metals are the materials that are preferentially used for this end and among the most frequently used are Al and Cu. These materials, although they have high values of thermal conductivity (hereinafter abbreviated as TC) of 235 and 398 Wm⁻¹K⁻¹ respectively, also have high Coefficient of Thermal Expansion (hereinafter abbreviated as CTE) values of 23 and 17×10⁻⁶ K⁻¹, respectively.

Due to this latter property, a problem of incompatibility arises at high temperatures between the thermal expansion of metals used as dissipaters and that shown by microelectronic devices, especially semiconductors and ceramic substrates, which have relatively low CTE values. For example, the CTE of silicon Si and gallium arsenide GaAs are 4.2 and 6.5×10⁻⁶ K⁻¹, respectively. Similarly, although the CTE of ceramic substrates that act as electrical insulators (Al₂O₃, AlN, SiC, diamond) are similar to those of the semiconductors, in many cases their TC values do not satisfy the requirements for adequate heat dissipation.

Also, although artificial diamond, which has excellent properties, has been used with some success, the excessive production costs (the impossibility of cutting and machining being one of its main limitations) make it non-viable in low cost components.

The differences in expansion of various components can be partially compensated using alloys of low melting points in the interface between the semiconductor device and the heat dissipater. However, their use is limited by their low elastic limit as thermal changes that occur during the functioning of the devices may induce thermal creep. The materials typically used for this end are alloys of Sn—Pb, etc.

Among the solutions adopted to resolve the problem of marked differences in thermal expansion in packaging architecture, it is interesting to mention the use of metal-metal composite materials with low CTE (e.g. Cu/W or Cu/Mo). However, the dissipaters manufactured with these materials have a TC similar to that of aluminum, which is excessively low.

With the purpose of satisfying the needs for thermal dissipation, in recent years a series of high performance composite materials have been developed, amongst which is Al/SiC, which has been broadly used in the industry and which has a thermal conductivity around 180 to 240 W/mK and with CTE of 7 to 9×10⁻⁶K⁻¹.

Currently, composite materials can be found on the market that are based on diamond, whose properties are much better than those mentioned above, as their TC easily exceeds 500 W/mK and their CTE varies in the range of 5 to 7×10⁻⁶ K⁻¹. The process of manufacture, described in Japanese patents 11-67991 and 10-223812, consists in making a porous preform of diamond, followed by a modification of the surface by covering it with an agent with good adherence to metal such as, for example, TiC. Subsequently, the porous preform is infiltrated with a metal alloy based on Ag or Cu. The main problem with these composite materials is their excessive production costs, the raw materials and the mechanisation costs being mainly responsible for their high prices.

A possible solution to this problem can be found in the European patent application EP 1168438 A2 where diamond is replaced by pyrolytic graphite. Unfortunately, although the machining costs can be reduced with these materials, the type of graphite used causes the production costs to continue to be high.

### DESCRIPTION OF THE INVENTION

The present invention's fundamental object is the development of a composite material with high thermal performance and low production cost to be used in semiconductor devices as a heat dissipater and a process for producing this material. Specifically, the materials that are the object of this invention have a thermal conductivity higher than 200 Wm⁻¹K⁻¹ and a coefficient of thermal expansion in the range of 2 to 10×10⁻⁶K⁻¹ (measured in the temperature range of 20 to 300° C. in at least two directions).

The composite material is composed of three phases: 1) a phase consisting mainly of graphite flakes (phase A); 2) a second phase (phase B) that comprises particles or fibers of a flake separating material, selected from a ceramic material (which is preferably selected from SiC, BN, AlN, TiB₂ and diamond) and carbon fibers, of high thermal performance in at least one direction; and finally, 3) a third phase (phase C) consisting of a metal alloy. Phases A and B are mixed, forming a preform in which the strongly orientated compact layers of phase A are alternated with the more diluted layers of phase B, enabling in this way the infiltration of the alloy (phase C).

Both the materials used and the manufacturing process chosen in this present invention enable keeping the production costs down to reasonable levels, achieving competitive thermal properties at the same time.

Although the three phases must have good thermal properties, it is phase A (graphite flakes) that is the principally responsible for the properties of the material that is the object of this invention. Phase B acts as a separator of the layers of phase A, enabling the infiltration of phase C, which consolidates the preform.

According to a preferred embodiment of the present invention, the component of phase B is selected from the group consisting of SiC, BN, AlN, TiB₂, diamond and carbon fibers. In the context of the present invention, carbon fibers of high thermal performance are those with thermal conductivity above 200 W m⁻¹K⁻¹, more preferably above 400 W m⁻¹K⁻¹, and a coefficient of thermal expansion in the range of 2 to 10×10⁻⁶ K⁻¹ (measured in the temperature range of 20 to 300° C. in at least one direction).

According to a preferred embodiment, phase C comprises a metal alloy, the main component of which is selected from Al, Ag and Cu, and alloying with at least one of the following elements (including the inevitable impurities): Si, Cr, Ti, V and B, preferably in amounts that can vary in the range of 0 to 15%. According to a more preferred embodiment, phase C comprises some alloy of the families Al—Si, Ag—Si or Cu—Cr, with the following being still more preferred: Al-12% Si, Ag-3% Si, Cu-0.1% Cr, Cu-0.3% Cr or Cu-1% Cr.

According to a preferred embodiment of the present invention, the graphite content of the composite material may vary in the range 10 to 80% by volume, the ceramic material or carbon fibers may vary in the range 15 to 70% by volume and finally, the infiltrated alloy content completes the remaining percentage.

In a preferred embodiment, the composite material of the invention comprises graphite flakes (phase A) in the range of 20 to 1000 μm in size, while phase B comprises carbon fibers in the range of 5 to 10 μm in diameter and in the range of 100 to 300 μm in length, or alternatively, ceramic particles in the range of 6 to 200 μm in size.

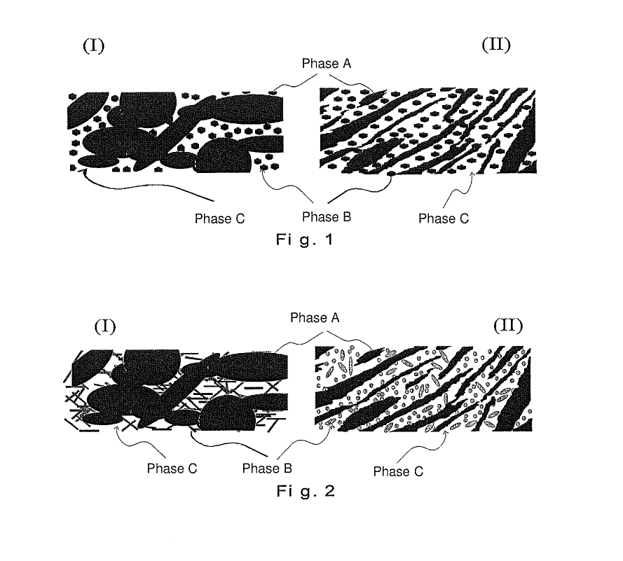

Based on the description above, and as shown in FIGS. 1 and 2, according to a preferred embodiment of the present invention the composite material of high thermal conductivity proposed in this invention comprises a first phase of graphite particles in the form of flakes (phase A), a second material of ceramic particles in the range of 6 to 200 μm in size or in the range of 6 to 170 μm (phase B) with high thermal conductivity values (e.g. SiC, BN, AlN, TiB₂, diamond, etc.) or carbon fibers of high thermal performance, and a third constituent (phase C) consisting of alloys of aluminum, silver or copper with a least one of the following elements: Si, Cr, Ti, V and B.

The preform is made by mixing the materials described as phases A and B, varying the content of phase B in the range 15 to 70% and either using or not using a non-polar organic solvent, for example hexane or cyclohexane. The mixture of the constituents, graphite flakes (phase A) and particles (phase B), preferably SiC, BN, diamond or carbon fibers, can be performed by any of the methods usually used by the industry, wet stirring, mechanical, magnetic stirring, etc. The excess non-polar solvent is removed and eliminated from the mixture by an appropriate technique that depends on the type of solvent used, various methods for the removal of solvents being known by an expert in the field.

The mixture of the components described as phase A and B in the various proportions established above is achieved in a resilient metal mould with the geometry desired. The plugs introduced into the mould cavity are lubricated in order to facilitate their removal. The mixtures are compacted under pressure, which is preferably 40 MPa or higher. The lower limit of pressure applied must be sufficiently high to guarantee the consolidation of the particles of the phases A and B, while the upper limit is reached when a substantial quantity of pores are closed, not allowing infiltration of the preform by the alloy. In this way, a porous preform is obtained with the distribution of the phases A and B that is desired. Once this has been compacted, it is removed from the mould.

The consolidated preform is placed into a temperature resistant mould (metal, ceramic, quartz, etc.). The process of infiltration is carried out by placing the preform on top of or under the infiltrating metal alloy. The metal alloy can be used in various ways: block, cylinder, scales, powder, etc. The alloy and the porous preform are kept separate during the heating and melting stage of the metal by means of a porous filter (for example aluminum paper). The quantity of alloy should be sufficient to fill all the pores of the preform in order to obtain a composite material with the minimum porosity possible.

The combination making up by phases A, B and C, as well as the metal mould containing them, is heated in a vacuum in order to prevent decomposition of phases with high carbon (graphite) content and to encourage the infiltration of phase C. The chamber may or may not be purged before the heating phase. Heating is carried out from ambient temperature to approximately 60 to 100° C. above the alloy melting point. For example, the temperature used for infiltration in the case of Al—Si alloys is chosen in the range of 660 to 700° C. and for Ag—Si alloys the temperature is in the range of 1000 to 1050° C.

Once the final infiltration temperature has been reached and after a period of time for temperature equalisation, pressure is applied, using a gas or other mechanical means as the compressing agent. The material obtained is solidified quickly, removing it from the heat source and taking it to a heat sink in order to obtain rapid and unidirectional cooling.

The composite material is produced in the forms and sizes that are most appropriate for its subsequent processing (cutting, machining, polishing, etc.) and use. It comprises layers of orientated graphite flakes alternating with layers of a composite material consisting of phases B and C. It is a light material, of high thermal conductivity and low coefficient of thermal expansion in at least two specified directions and which presents no problem for cutting, machining and polishing.

During the description and the claims, the words “comprising”, “composed of” and their variants are not intended to exclude other technical characteristics, additives, components or steps. The content of the application, the priority of which is claimed, as well as the contents of the priority application summaries and the present application are incorporated here as a reference.

For an expert in the field, other objects, advantages and characteristics of the invention will emerge partly from the description and partly from the practice of the invention. The following examples and figures are provided for the purpose of illustration only and are not intended to be limiting of the present invention.

### BRIEF DESCRIPTION OF THE FIGURES

FIG. 1 Longitudinal (I) and transverse (II) views of the material described in the present invention composed of three phases:
Phase A: graphite flakes.
Phase B: a separating material in the form of particles, preferably a ceramic.
Phase C: a metal alloy.

FIG. 2 Longitudinal (I) and transverse (II) views of the material described in the present invention composed of three phases:
Phase A: graphite flakes.
Phase B: a separating material in the form of fibers, preferably carbon fibers.
Phase C: a metal alloy.

### DETAILED DESCRIPTION OF EXAMPLES OF EMBODIMENT

### Example 1

To manufacture this material, the following were used for phases A and B (see FIG. 1): graphite flakes of 400 μm in diameter and particles of SiC of an average of 13 μm in diameter respectively. The proportions of phases A and B were varied over the range of 30 to 55% and 61 to 33% by volume respectively. Phase C in this case was a eutectic alloy of Al-12% Si. The alloy was chosen to minimize the melting temperature and maximize the compatibility with the reinforcements. The volume fraction of phase C is equal to the part remaining of the sum of the volume fractions of phases A and B. A detailed description of the volume fractions in each phase used is shown in Table 1.

The material of the present example was manufactured according to the following stages:
a) Phases A and B were mixed in the wet with a non-polar solvent (hexane). The quantity of solvent must enable homogenous mixing of the phases A and B. The mixing process was performed using mechanical stirring. The mixture was filtered to remove the liquid phase and the remaining solvent was evaporated by heating to 90° C.
b) The mixture of phases A and B was consolidated under a pressure of 40 MPa in a metal mould sufficiently strong to withstand the compaction pressure. The pressure was applied by means of a previously lubricated piston. Using this procedure, a preferred orientation of the graphite flakes (phase A) was achieved.
c) The compacted preform was removed from the mould and placed in an infiltration chamber next to the alloy (phase C). The preform and the metal were separated by a porous filter during the heating stage, which was performed in a vacuum. The infiltration temperature depends on the chosen alloy; in this case it was 660° C.
d) The preform was infiltrated under pressure using a pressurised gas (nitrogen). The material obtained was rapidly solidified, taking it away from the heat source and moving it to a heat sink.

The composite material manufactured in this way was characterised in having orientated graphite flakes (phase A), alternating with layers of a composite material consisting of phases B and C. In Table 1 the values of TC and CTE for various samples obtained in this example, in the plane defined by the graphite flakes, are shown. The test samples used for the measurements of TC and CTE (of dimensions 50×10×10 mm and 8×4×4 mm respectively) were cut (machined and polished) from the samples manufactured according to the process described above, the dimensions of which were 52×11×11 mm in this case.

TABLE 1

| | Phase A | Phase B | Phase C | | |
|---|---|---|---|---|---|
| | Graphite | SiC | Al—12%Si | | CTE |
| | flakes. | particles | alloy | TC (W/mK) | ×10⁻⁶ K⁻¹ |
| Sample | (%) | (%) | (%) | (in the plane) | (in the plane) |
| 1 | 55 | 33 | remainder | 415 | 7.8 |
| 2 | 45 | 48 | remainder | 342 | 9.4 |
| 3 | 43 | 52 | remainder | 326 | 8.4 |
| 4 | 30 | 61 | remainder | 322 | 7.8 |

TC measured according to the ASTM E 1225 standard.
CTE measured according to the ASTM E 831 standard.

### Example 2

To manufacture this material, the following were used for phases A and B (see FIG. 1): graphite flakes of 400 μm in diameter and particles of SiC of an average of 22 μm in diameter respectively. The proportions of phases A and B were varied over the range of 32 to 60% and 53 to 27% by volume respectively. Phase C in this case was a eutectic alloy of Al-12% Si. The alloy was chosen to minimize the melting temperature and maximize the compatibility with the reinforcements. The volume fraction of phase C is equal to the part remaining of the sum of the volume fractions of phases A and B. A detailed description of the volume fractions in each phase used is shown in Table 2.

The material of the present example was manufactured according to the processes described in stages a)-d) of Example 1: mixing, consolidation of the preform, melting of the metal stage, infiltration and finally solidification of the metal.

The composite material manufactured in this way was characterised in having graphite flakes (phase A), alternating with layers of a composite material consisting of phases B and C. In Table 2 the values of TC and CTE for various samples obtained in this example, in the plane defined by the graphite flakes, are shown. The test samples used for the measurements of TC and CTE (of dimensions 50×10×10 mm and 8×4×4 mm respectively) were cut (machined and polished) from the samples manufactured according to the process described above, the dimensions of which were 52×11×11 mm in this case.

TABLE 2

| | Phase A | Phase B | Phase C | | |
|---|---|---|---|---|---|
| | Graphite | SiC | Al—12%Si | | CTE |
| | flakes. | particles | alloy | TC (W/mK) | ×10⁻⁶ K⁻¹ |
| Sample | (%) | (%) | (%) | (in the plane) | (in the plane) |
| 1 | 60 | 27 | remainder | 390 | 6.0 |
| 2 | 53 | 35 | remainder | 368 | 7.0 |
| 3 | 32 | 48 | remainder | 323 | 9.0 |
| 4 | 32 | 53 | remainder | 294 | 9.6 |

TC measured according to the ASTM E 1225 standard.
CTE measured according to the ASTM E 831 standard.

### Example 3

To manufacture the material of this example, the following were used for phases A and B (see FIG. 1): graphite flakes of 400 μm in diameter and particles of SiC in the range of 6 to 170 μm in diameter respectively. The proportions of phases A and B were varied over the range of 42 to 77% and 44 to 18% by volume respectively. Phase C in this case was a eutectic alloy of Al-12% Si. The alloy was chosen to minimize the melting temperature and maximize the compatibility with the reinforcements. The volume fraction of phase C is equal to the part remaining of the sum of the volume fractions of phases A and B. A detailed description of the volume fractions in each phase used is shown in Table 3.

The material of the present example was manufactured according to the processes described in stages a)-d) of Example 1: mixing, consolidation of the preform, melting of the metal stage, infiltration and finally solidification of the metal.

The composite material manufactured in this way was characterised in having graphite flakes (phase A), alternating with layers of a composite material consisting of phases B and C. In Table 3 the values of TC and CTE for various samples obtained in this example, in the plane defined by the graphite flakes, are shown. The test samples used for the measurements of TC and CTE (of dimensions 50×10×10 mm and 8×4×4 mm respectively) were cut (machined and polished) from the samples manufactured according to the process described above, the dimensions of which were 52×11×11 mm in this case.

TABLE 3

| | Phase A | Phase B | Phase C | Particle | | CTE |
|---|---|---|---|---|---|---|
| | Graphite | SiC | Al—12%Si | size (μm) | TC (W/mK) | ×10⁻⁶ K⁻¹ |
| Sample | flakes. (%) | particles (%) | alloy (%) | Phase B | (in the plane) | (in the plane) |
| 1 | 46 | 44 | remainder | 6 | 342 | 7.7 |
| 2 | 42 | 42 | remainder | 8 | 399 | 7.8 |
| 3 | 55 | 33 | remainder | 12 | 415 | 7.8 |
| 4 | 53 | 35 | remainder | 25 | 368 | 7.0 |
| 5 | 48 | 44 | remainder | 40 | 400 | 6.5 |
| 6 | 77 | 18 | remainder | 170 | 437 | 5.8 |

TC measured according to the ASTM E 1225 standard.
CTE measured according to the ASTM E 831 standard.

### Example 4

To manufacture the material of this example, the following were used for phases A and B (see FIG. 1): graphite flakes of 400 μm in diameter and particles of SiC of an average of 13 μm in diameter. The proportions of phases A and B were varied over the range of 32 to 56% and 49 to 24% by volume respectively. Phase C in this case was a eutectic alloy of Ag-3% Si. The alloy was chosen to minimize the melting temperature and maximize the compatibility with the reinforcements. The volume fraction of phase C is equal to the part remaining of the sum of the volume fractions of phases A and B. A detailed description of the volume fractions in each phase used is shown in Table 4.

The material of the present example was manufactured according to the processes described in stages a)-d) of Example 1: mixing, consolidation of the preform, melting of the metal stage, infiltration and finally solidification of the metal. There were two differences with respect to the process in Example 1: i) the mixing of the phases A and B were performed using cyclohexane as the solvent in place of hexane, and ii) the melting of phase C was carried out at 1000° C.

The composite material manufactured in this way was characterised in having orientated graphite flakes (phase A), alternating with layers of a composite material consisting of phases B and C. In Table 4 the values of TC and CTE for various samples obtained in this example, in the plane defined by the graphite flakes, are shown. The test samples used for the measurements of TC and CTE (of dimensions 50×10×10 mm and 8×4×4 mm respectively) were cut (machined and polished) from the samples manufactured according to the process described above, the dimensions of which were 52×11×11 mm in this case.

TABLE 4

| | Phase A | Phase B | | | |
|---|---|---|---|---|---|
| | Graphite | SiC | Phase C | | CTE |
| | flakes. | particles | Ag—3%Si | TC (W/mK) | ×10⁻⁶ K⁻¹ |
| Sample | (%) | (%) | (%) | (in the plane) | (in the plane) |
| 1 | 56 | 24 | remainder | 413 | 7.3 |
| 2 | 53 | 31 | remainder | 360 | 8.2 |
| 3 | 32 | 49 | remainder | 302 | 8.6 |

TC measured according to the ASTM E 1225 standard.
CTE measured according to the ASTM E 831 standard.

### Example 5

To manufacture this material, the following were used for phases A and B (see FIG. 1) graphite flakes of 400 μm in diameter and high thermal performance carbon fibers of 100 to 300 μm in average length and of 5 to 10 μm in average diameter. The contents of phases A and B were fixed at 75% and 10% by volume respectively. As phase C, the eutectic alloys Al-12% Si and Ag-3% Si and the alloys Cu-x % Cr (x=0.0, 0.1, 0.3 and 1.0) were selected. The alloy was chosen to minimize the melting temperature and maximize the compatibility with the reinforcements. The volume fraction of phase C is equal to the part remaining of the sum of the volume fractions of phases A and B. A detailed description of the volume fractions in each phase used is shown in Table 5.

The material of the present example was manufactured according to the processes described in stages a)-d) of Example 1: mixing, consolidation of the preform, melting of the metal stage, infiltration and finally solidification of the metal. In this case, the selected melting temperatures were: 660° C. for the alloy Al-12% Si, 1000° C. for Ag-3% Si, and 1200° C. for the alloys Cu-x % Cr.

The composite material manufactured in this way was characterised in having orientated graphite flakes (phase A), alternating with layers of a composite material consisting of phases B and C. In Table 5 the values of TC and CTE for various samples obtained in this example, in the plane defined by the graphite flakes, are shown. The test samples used for the measurements of TC and CTE (of dimensions 50×10×10 mm and 8×4×4 mm respectively) were cut (machined and polished) from the samples manufactured according to the process described above, the dimensions of which were 52×11×11 mm in this case.

TABLE 5

| | Phase A | Phase B | | | | CTE |
|---|---|---|---|---|---|---|
| | Graphite | Carbon | Phase C | Phase C | TC (W/mK) | ×10⁻⁶ K⁻¹ |
| Sample | flakes (%) | fiber (%) | Alloy (%) | Alloy | (in the plane) | (in the plane) |
| 1 | 75 | 10 | remainder | Al—12%Si | 367 | 3.0 |
| 2 | 75 | 10 | remainder | Cu | 403 | 2.5 |
| 3 | 75 | 10 | remainder | Cu—0.1%Cr | 231 | 3.0 |
| 4 | 75 | 10 | remainder | Cu—0.3%Cr | 457 | 3.0 |
| 5 | 75 | 10 | remainder | Cu—1%Cr | 298 | 2.0 |
| 6 | 75 | 10 | remainder | Ag—3%Si | 548 | 3.0 |

TC measured according to the ASTM E 1225 standard.
CTE measured according to the ASTM E 831 standard.

### Example 6

To manufacture this material, the following were used for phases A and B (see FIG. 1): graphite flakes of 400 μm in diameter and particles of diamond of 100 μm in diameter. The proportions of phases A and B were fixed at 60% and 20% by volume respectively. As phase C, the eutectic alloys Al-12% Si and Ag-3% Si were selected. The alloy was chosen to minimize the melting temperature and maximize the compatibility with the reinforcements. The volume fraction of phase C is equal to the part remaining of the sum of the volume fractions of phases A and B. A detailed description of the volume fractions in each phase used is shown in Table 6.

The material of the present example was manufactured according to the processes described in stages a)-d) of Example 1: mixing, consolidation of the preform, melting of the metal stage, infiltration and finally solidification of the metal. In this case, the selected melting temperatures were: 660° C. for the alloy Al-12% Si, 1000° C. for Ag-3% Si.

The composite material manufactured in this way was characterised in having orientated graphite flakes (phase A), alternating with layers of a composite material consisting of phases B and C. In Table 6 the values of TC and CTE for various samples obtained in this example, in the plane defined by the graphite flakes, are shown. The test samples used for the measurements of TC and CTE (of dimensions 50×10×10 mm and 8×4×4 mm respectively) were cut (machined and polished) from the samples manufactured according to the process described above, the dimensions of which were 52×11×11 mm in this case.

TABLE 6

| | Phase A | Phase B | | | | CTE |
|---|---|---|---|---|---|---|
| | Graphite | diamond | Phase C | Phase C | TC (W/mK) | ×10⁻⁶ K⁻¹ |
| Sample | flakes (%) | particles (%) | alloy (%) | alloy | (in the plane) | (in the plane) |
| 1 | 60 | 20 | remainder | Al—12%Si | 451 | 4.4 |
| 2 | 60 | 20 | remainder | Ag—3%Si | 253 | 6.4 |

TC measured according to the ASTM E 1225 standard.
CTE measured according to the ASTM E 831 standard.

1. Composite material comprising:
i) Phase A: graphite particles in the form of flakes;
ii) Phase B: particles or fibers of a flake separating material;
iii) Phase C: metal alloy, composed of an alloy where a major component is a metal selected from the group consisting of aluminum, silver and copper; alloying with at least one of the following elements: Si, Cr, Ti, V and B, together with the inevitable impurities.

2. The composite material according to claim 1, wherein the component of phase B is selected from the group consisting of SiC, BN, AlN, TiB₂, diamond and carbon fibers.

3. The composite material according to claim 1, wherein phase A and phase B are intimately mixed forming a compact preform into which phase C is infiltrated.

4. The composite material according to claim 1, wherein phase C comprises an alloy Al—Si, Ag—Si or Cu—Cr.

5. The composite material according to claim 1, wherein it comprises:
i) between 10 and 80% phase A by volume;
ii) between 15 and 70% phase B by volume;
iii) the remainder of phase C.

6. The composite material according to claim 1, wherein
i) the graphite flakes are between 20 and 1000 μm in size;
ii) phase B comprises carbon fibers of an average of 5 to 10 μm in diameter and an average of 100 to 300 μm in length, or, alternatively, particles of ceramic of average diameter in the range of 6 to 200 μm.

7. The composite material according to claim 1, wherein:
that it has layers of orientated graphite flakes (phase A) alternating with layers of a composite material consisting of phases B and C.

8. (canceled)

9. A process for the manufacture of a composite material according to claim 1, comprising:
a) mixing the graphite flakes with particles of ceramic material or alternatively carbon fibers;
b) moulding, by means of pressure, the mixture of stage a) as a porous preform;
c) placing the porous preform obtained in stage b) next to the metal for performing the infiltration of the alloy;
d) heating the assembly until a temperature slightly higher than the melting point of the alloy has been reached and the application of pressure to force the alloy to infiltrate the pores of the preform.

10. Use of the composite material according to claim 1 configured as a contact heat dissipater in microelectronic, optoelectronic devices and power generators.
